(19) United States
(12) Patent Application Publication
(10) Pub. No.: US 2015/0284156 A1
(43) Pub. Date: Oct. 8, 2015

(54) Bio-degradable Compostable Valve

(71) Applicant: INNOVATIVE MOLD SOLUTIONS, INC., Leominster, MA (US)

(72) Inventor: Derek Helmer, Groton, MA (US)

(73) Assignee: INNOVATIVE MOLD SOLUTIONS, INC., Leominster, MA (US)

(21) Appl. No.: 14/675,843

(22) Filed: Apr. 1, 2015

Related U.S. Application Data
(60) Provisional application No. 61/973,946, filed on Apr. 2, 2014.

(51) Int. Cl. B65D 51/16; F16K 27/02

(52) U.S. Cl. CPC B65D 51/1644; F16K 27/0209

(57) ABSTRACT

A bio-degradable compostable valve is presented. The valve includes a base having a first surface, a second surface and at least one hole therethrough. The valve further includes a filter in mechanical communication with a first surface of the base. Also included is a diaphragm having a first surface and a second surface, the first surface having oil thereon, the first surface in mechanical communication with a second surface of the base. Additionally the valve includes a cap having a first surface, a second surface, and a hole extending therethrough, wherein the cap is in mechanical communication with the diaphragm and the second surface of the base. The base, the filter, the diaphragm and the cap are comprised of material which is bio-degradable and compostable.

### CROSS REFERENCE TO RELATED APPLICATIONS

The present application claims the benefit of U.S. Provisional Patent Application No. 61/973,946, filed on Apr. 2, 2014, which is incorporated herein by reference in its entirety.

### BACKGROUND

This disclosure relates to valve devices and methods and, more particularly, to a method and system for creation of a bio-degradable compostable valve. Air tight packages do not allow for the escape of gases from inside the bag. In some applications, a manufacturer will require that a gas generated by the material being packaged in a container such as a bag is allowed to exit the bag without the re-entry of ambient air.

Valves exist for this application but the presently described bio-degradable compostable valve uses certified compostable materials for all components of the valve allowing applications that use compostable bags to come into compliance with ASTM D6400 content regulations by using a compostable valve.

### SUMMARY

Conventional mechanisms such as those explained above suffer from a variety of deficiencies. One such deficiency is that valves intended for this type of use are not both bi-degradable and compostable. As defined herein, a product is biodegradable as long as it will completely break down and return to nature (i.e., decompose into elements found in nature) within a reasonably short period of time after customary disposal. In other words, the item will continue to disintegrate into small pieces until micro-organisms consume it. For an item to be marked compostable, there must be scientific evidence that the materials in the item break down, or become part of, usable compost in a safe and timely manner in an appropriate composting facility or home compost pile.

The main difference between biodegradable and compostable is the latter breaks down into “humus,” which provides valuable nutrients to the soil. Biodegradable products just return to nature, disintegrating or disappearing completely. This disintegration could take a week or years—another difference with compostable, where items must break down in a “timely” fashion i.e., one-to-four months. Finally, compostable items must completely break down and not release any metals or toxins into the compost. Biodegradable products can leave metal residue in their return to nature. Biodegradeable refers to the break down of the carbon content of the material in a “reasonable timeframe”. This timeframe is loosely defined. There are four specific criteria for a material to be labeled compostable. First, it must biodegrade—at least 90% carbon content must go away within 90-180 days. Second, it must disintegrate—at least 90% of the material must disintegrate within 84 days. Third, it must not contain heavy metals above concentrations defined by North America or EU restrictions. Fourth, the disintegrated content must support future plant growth as humus. These four conditions are tested per the ASTM D6400 standard.

Embodiments of the invention significantly overcome such deficiencies and provide mechanisms and techniques that provide a bio-degradable compostable one-way valve conference.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below. All examples and features mentioned below can be combined in any technically possible way.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 comprises an exploded view of a bio-degradable compostable valve in accordance with embodiments of the invention.

FIGS. 2A through 2E comprises various views of a base of the bio-degradable compostable valve in accordance with embodiments of the invention.

FIGS. 3A through 3E comprises various views of a cap of the bio-degradable compostable valve in accordance with embodiments of the invention.

FIG. 4 depicts the bio-degradable compostable valve disposed on a surface of a bag in accordance with embodiments of the invention.

FIG. 5A and 5B comprise various views of an alternative base of the bio-degradable compostable valve in accordance with embodiments of the invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

The presently described bio-degradable compostable valve will be described with respect to the coffee industry; however the invention is not limited to this particular industry. When coffee is roasted, the roasted coffee continues to release carbon dioxide for a period of time. To leave the roasted and ground beans out until the outgassing is complete depletes the flavor of the coffee. Bagging the roasted and ground beans prior to outgassing will result in bags exploding while in inventory. The application of a valve to the bag allows the gas to escape as it is generated and the coffee to be packed as quickly as possible after roasting.

The valve opens to ambient air under minimal pressure e.g., 3-13 mill bars (mb). The valve re-seals after the pressure drops below the break pressure limit. This allows gas to escape during outgassing of the material contained in the bag as well as ambient pressure differences such as transportation in higher altitudes. The valves also allow trapped air to escape from the bag when the bag is compressed due to packing into a master container or palletizing. The valve prevents air from entering the bag.

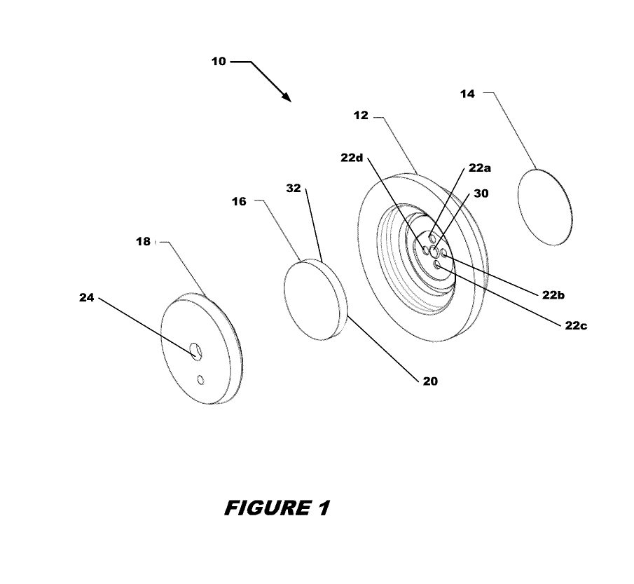

The valve is snapped together and is not intended to be serviced or dis-assembled. The valve is comprised of five components as shown in FIG. 1. The valve 10 includes a base 12, a filter 14, a diaphragm 16 and a cap 18. Oil 20 is also applied to the first surface 32 of diaphragm 16 that faces base 12.

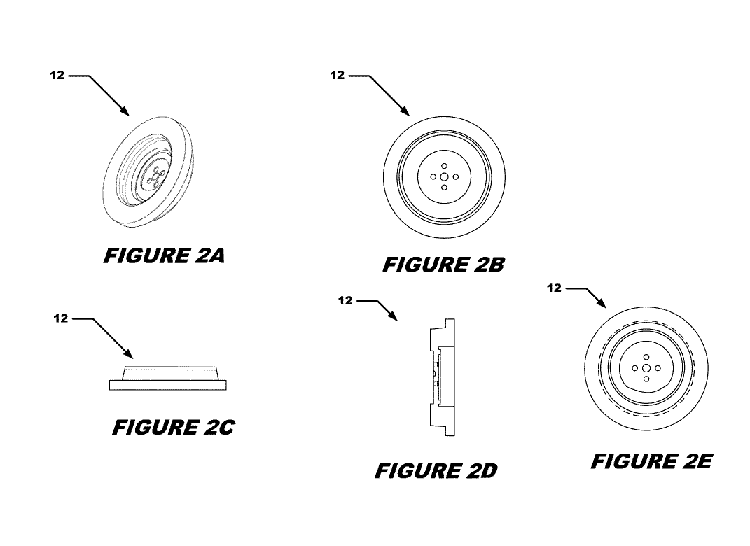

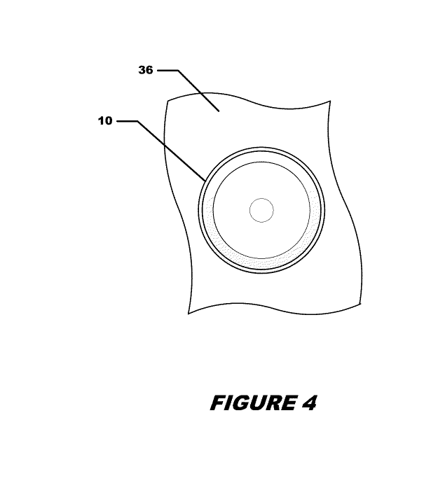

Referring now to FIGS. 2A through 2E various views of base 12 are shown. Base 12 achieves a number of functions. Base 12 provides a seal surface to assemble the valve 10 to a bag 36 (shown in FIG. 4). Base 12 also contains a location and features to seal the filter material 14. Base 12 contains a plurality of holes 22a, 22b, 22c and 22d to allow gas in the bag to pass through. Base 12 also contains a central post 30 which prevents diaphragm 16 from contacting the holes 22a-22d. The base 12 is made from a compostable polymer.

Filter 14 is also shown. Filter 14 comprises a membrane which 14 fits against a surface of base 12 and prevents the material within of the bag (e.g., ground coffee) from entering the valve 10. Filter 14 is comprised of a PLA non-woven fabric.

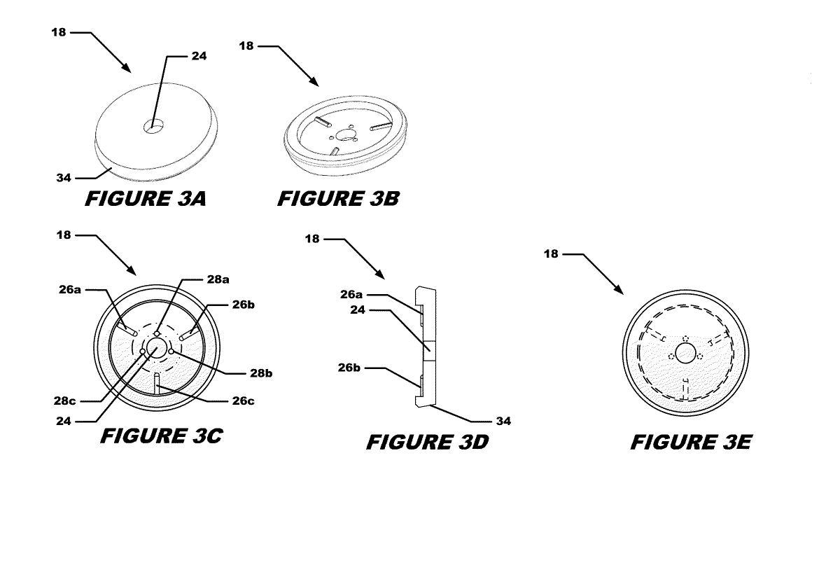

Referring now to FIGS. 3A through 3E, various views of cap 18 are shown. Cap 18 functions to hold the assembly together through a snap fit with the base 12 by way of tapered sidewall 34. Cap 18 also contains a hole 24 to allow gas to flow to atmosphere once passing the diaphragm. Cap 18 contains features to prevent the diaphragm from exceeding the minimum and maximum travel limits during operation including ribs 26a, 26b and 26c and further including posts 28a, 28b and 28c. The posts 28a-c and the ribs 26a-c prevent the diaphragm 16 from sticking to the cap 18. Cap 18 is comprised of a polylactic acid polymer.

Referring back to FIG. 1, diaphragm 16 is shown. Diaphragm 16 provides a sealing surface for the valve 10. Diaphragm 16 includes a first surface 32 which faces the base 12 and includes oil 20. The oil 20 enhances the seal between the diaphragm 16 and the base 12. The diaphragm is a PLA based elastomer while the oil is a silicone which is 1-3 percent non-compostable by weight. While the oil by itself is not bio-degradable or compostable, such a small amount is used that the bio-degradable and compostable regulations are met.

In a particular embodiment the valve comprises a base having a first surface, a second surface and at least one hole therethrough. In this embodiment the base includes a post, the post disposed within a central area on the second surface of the base and extending therefrom. The at least one hole of the base comprises four holes equally spaced around the post of the base. The base is comprised of a polylactic acid (PLA) polymer.

The valve further includes a filter in mechanical communication with a first surface of the base. The filter is comprised of a polylactic acid (PLA) non-woven fabric.

The valve also includes a diaphragm having a first surface and a second surface, the first surface having oil thereon, the first surface in mechanical communication with a second surface of the base. The diaphragm is comprised of a polylactic acid (PLA) based elastomer.

Additionally, the valve includes a cap having a first surface, a second surface and a hole extending therethrough. The cap is in mechanical communication with the diaphragm and the second surface of the base. The cap includes three posts, each post disposed on the second surface of the cap and extending therefrom, each post equally spaced around the hole of the cap. The cap further includes three ribs, each rib disposed on the second surface of the cap and extending therefrom, each rib equally spaced around the hole of the cap. The cap includes a tapered sidewall and is capable of being snap fit within the base. The cap is comprised of a polylactic acid (PLA) polymer.

The valve 10 may be part of an assembly which includes a bag 36 as shown in FIG. 4. The valve 10 is disposed within a surface of the bag 36. Bag 36 is used to store the material which needs to be vented (e.g. coffee or the like).

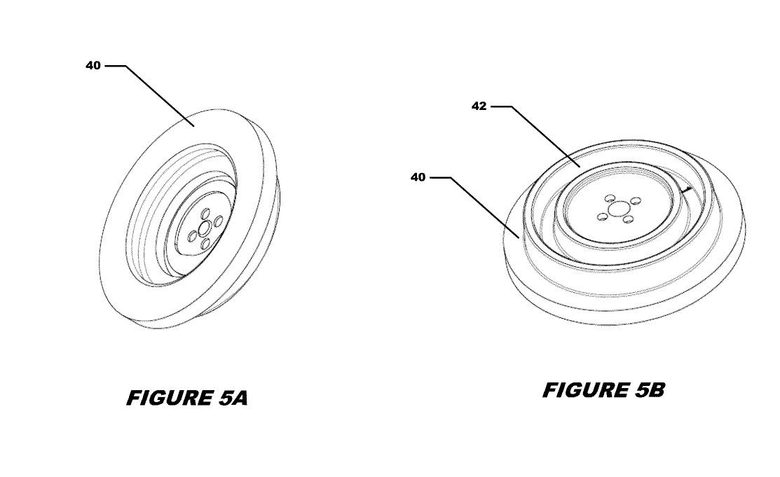

An alternate embodiment of the base 40 is shown in FIGS. 5A and 5B. this embodiment of the base includes a deep groove 42 around a top face of the valve where added geometry increases the surface area and decreases the time required to compost.

All materials used in the manufacture of the valve 10 are certified to ASTM D6400 standard for compostability. Further, the number and position of various holes, posts and the like are described with respect to a specific embodiment. It should be understood that any number of holes, posts and the like may be used.

The silicone oil as a raw material component is not certified ASTM D6400 compostable. However as a finished valve, the trace amount of this material used will meet the requirements for compostability.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Accordingly, it is submitted that that the invention should not be limited to the described embodiments but rather should be limited only by the spirit and scope of the appended claims.

What is claimed is:

1. A bio-degradable compostable valve comprising:
a base having a first surface, a second surface and at least one hole therethrough;
a filter in mechanical communication with a first surface of said base;
a diaphragm having a first surface and a second surface, said first surface having oil thereon, said first surface in mechanical communication with a second surface of said base;
a cap having a first surface, a second surface and a hole extending therethrough, wherein said cap is in mechanical communication with said diaphragm and said second surface of said base; and
wherein said base, said filter, said diaphragm and said cap are comprised of material which is bio-degradable and compostable.

2. The bio-degradable compostable valve of claim 1 wherein said base includes a post, said post disposed within a central area on said second surface of said base and extending therefrom.

3. The bio-degradable compostable valve of claim 2 wherein said at least one hole of said base comprises four holes equally spaced around said post of said base.

4. The bio-degradable compostable valve of claim 1 wherein said cap includes at least one post, each of said at least one post disposed on said second surface of said cap and extending therefrom, each of said at least one post equally spaced around said hole of said cap.

5. The bio-degradable compostable valve of claim 1 wherein said cap includes at least one rib, each of said at least one rib disposed on said second surface of said cap and extending therefrom, each of said at least one rib equally spaced around said hole of said cap.

6. The bio-degradable compostable valve of claim 1 wherein said cap has a tapered sidewall.

7. The bio-degradable compostable valve of claim 1 wherein said cap is capable of being snap fit within said base.

8. The bio-degradable compostable valve of claim 1 further comprising a bag, said valve disposed within a surface of said bag.

9. The bio-degradable compostable valve of claim 1 wherein said base is comprised of a compostable polymer.

10. The bio-degradable compostable valve of claim 1 wherein said cap is comprised of a polylactic acid (PLA) polymer.

11. The bio-degradable compostable valve of claim 1 wherein said filter is comprised of a polylactic acid (PLA) non-woven fabric.

12. The bio-degradable compostable valve of claim 1 wherein said diaphragm is comprised of a polylactic acid (PLA) based elastomer.

13. The bio-degradable compostable valve of claim 1 wherein said oil is comprised of a. Silicone 1-3 percent non-compostable by weight.

14. The bio-degradable compostable valve of claim 1 wherein said base includes deep groove around a top face of said valve.
